(19) United States
(12) Patent Application Publication
(10) Pub. No.: US 2026/0061503 A1
(43) Pub. Date: Mar. 5, 2026

(54) ADDITIVELY MANUFACTURED CUTTING TOOLS WITH THRU-COOLANT CHANNELS

(71) Applicant: Kennametal Inc., Latrobe, PA (US)

(72) Inventor: Tyler Grimm, Greensburg, PA (US)

(73) Assignee: Kennametal Inc., Latrobe, PA (US)

(21) Appl. No.: 19/318,879

(22) Filed: Sep. 4, 2025

Related U.S. Application Data
(60) Provisional application No. 63/690,972, filed on Sep. 5, 2024.

(51) Int. Cl. B23C 5/28; B23C 5/10

(52) U.S. Cl. CPC B23C 5/28; B23C 5/10

(57) ABSTRACT

Additively manufactured cutting tools with through coolant channels are disclosed. The cutting tool may be a rotary cutting tool with a rear shank portion, a cutting portion with flutes extending from the shank portion along a longitudinal axis, a central coolant supply channel extending along the shank portion and the cutting portion, contoured radial coolant channels in flow communication with the central coolant channel, and outlet ports arranged to direct coolant fluid in desired portions to selected locations of the cutting portion during operation.

### CROSS REFERENCE TO RELATED APPLICATION

This application claims the benefit of U.S. Provisional Ser. No. 63/690,972 filed Sep. 5, 2024, which is incorporated herein by reference.

### FIELD OF THE INVENTION

The present invention relates to additively manufactured cutting tools, such as end mills and other rotary cutting tools, with thru-coolant channels.

### BACKGROUND INFORMATION

End mills and other rotary cutting tools are used in the machine tool industry to cut various types of materials, including metals, carbon fiber, plastics and the like. These tools are often operated at high cutting temperatures in the cutting zone, and require coolant to be delivered to the cutting zone during operation.

### SUMMARY OF THE INVENTION

The present invention provides additively manufactured rotary cutting tools such as end mills with through coolant channels. A central coolant supply channel may extend along the longitudinal axis of the cutting tool, with radial coolant channels in fluid communication with the central coolant channel. The radial coolant channels extend from the central coolant channel to outlet ports located at selected positions on the cutting tool.

By utilizing additive manufacturing, advanced coolant channel designs can be implemented. End mills with coolant channels and outlet ports are primarily described herein, but this invention also applies to drills, taps and turning inserts/tools. For example, the coolant channel designs may be implemented in solid end mills.

### BRIEF DESCRIPTION OF THE DRAWINGS

FIG. 1 is a side view and FIG. 2 is an isometric rear end view of an additively manufactured solid end mill with through-coolant channels in accordance with an embodiment of the present invention.

FIG. 3 is an enlarged side view of a portion of the solid end mill of FIGS. 1 and 2 illustrating a coolant channel outlet port located in a flute and directed at a rake face of the end mill in accordance with an embodiment of the present invention.

FIG. 4 is a front cutaway end view of the end mill of FIGS. 1-3 illustrating through coolant channels and outlet ports in the flutes directed toward the rake faces of the end mill.

FIGS. 5-7 are 3D solid models illustrating through coolant channels and outlet ports in solid form that are subtracted from the tool body during additive manufacturing to form the coolant channels and outlet ports.

FIG. 8 is a cross-sectional end view of a solid end mill with through coolant channels and outlet ports directed into the flutes toward the rake faces of the end mill.

FIG. 9 is a side view of another additively manufactured solid end mill including through coolant channels and outlet ports directed into the flutes toward the rake faces of the end mill. Sections A-A through L-L of FIG. 9 are shown in FIGS. 9A-9L as cross-sectional views taken from the side view, illustrating the arrangement of through coolant channels and outlet ports at different locations along the axial length of the end mill.

FIG. 10 is a cross-sectional end view of a solid end mill including through coolant channels and outlet ports in accordance with another embodiment of the present invention. In this embodiment, the coolant outlet ports are located in the flank-face of the end mill.

### DETAILED DESCRIPTION

Cutting tools of the present invention address the issues mentioned above by providing tools that may allow for increased cooling of cutting edges with controlled coolant fluid flow during operating conditions. As used herein, the term “fluid” may refer to water, oils, or other liquids, and/or gas that may pass through the through rotary cutting tools.

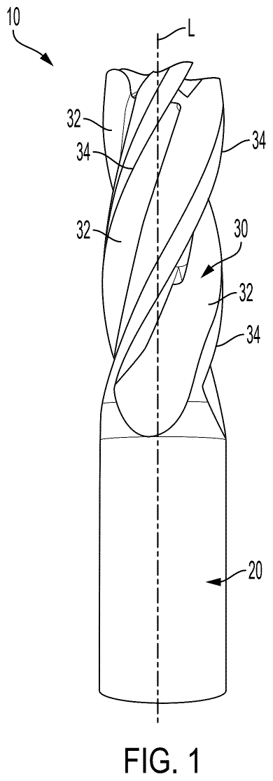

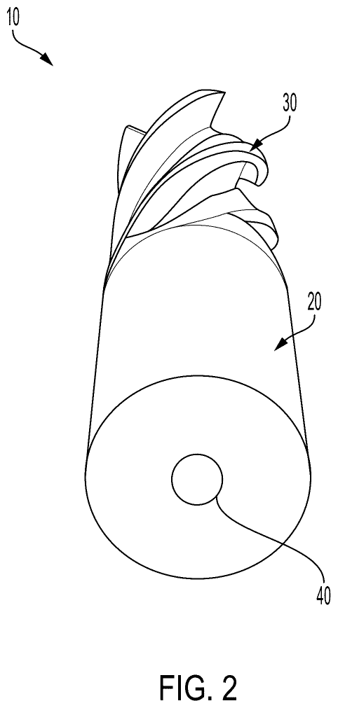

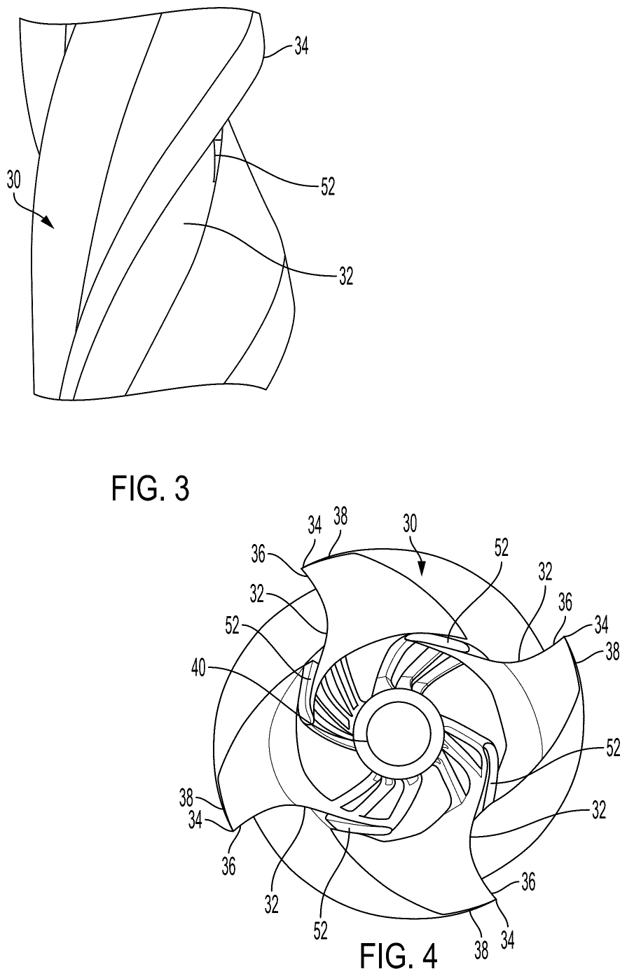

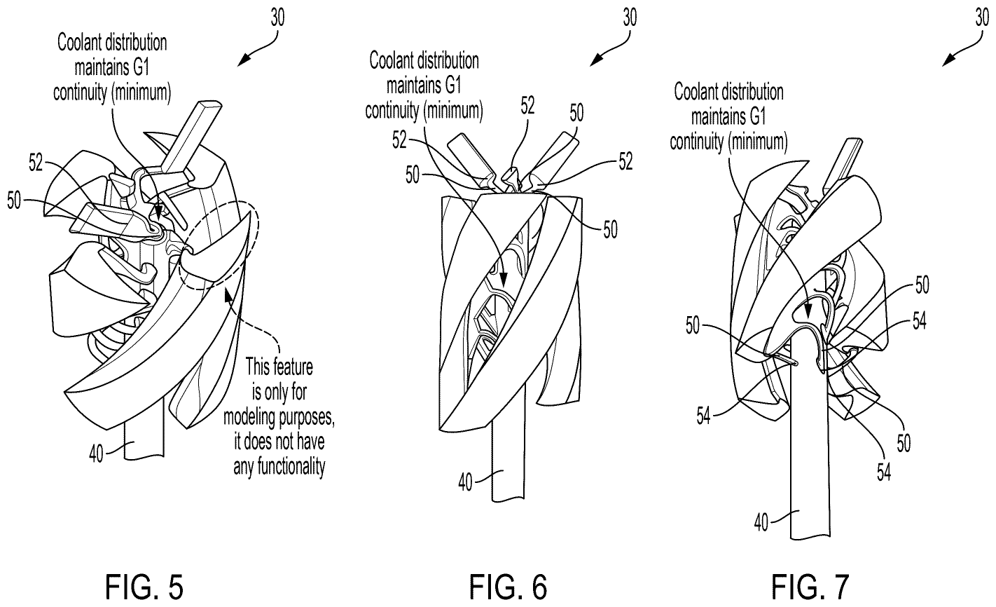

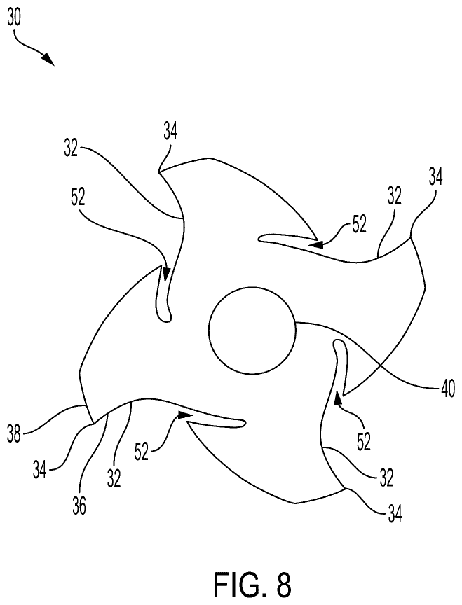

### Type 1: Rake-Face—FIGS. 1-9

An embodiment of the present invention is to form a “sleeve” of coolant which flows along substantially the entire rake face of a cutting tool, such as a solid end mill or the like. As a chip is formed along the rake face, the “sleeve” is targeted to flow under the chip (between the chip and the rake face). By directing the flow of coolant underneath the chip, the friction between the chip and the tool is reduced. High pressure coolant will also impart relatively high pressure on the chip, causing it to break, which is advantageous because small chips are better than large chips.

Coolant may exit at any point along the chip gash/rake face. It can be closer or further from the cutting edge. The slot(s) may extend across the entire length of flute(s) or only cover a portion of the flute(s). The slot(s) may only be present on a certain number of flutes or they may be on all flutes. Multiple individual slots may be present on a single flute, which are separated by some distance. Various coolant pressures can be used and coolant types (e.g. MQL). Different tool materials can be used (e.g. carbide, HSS).

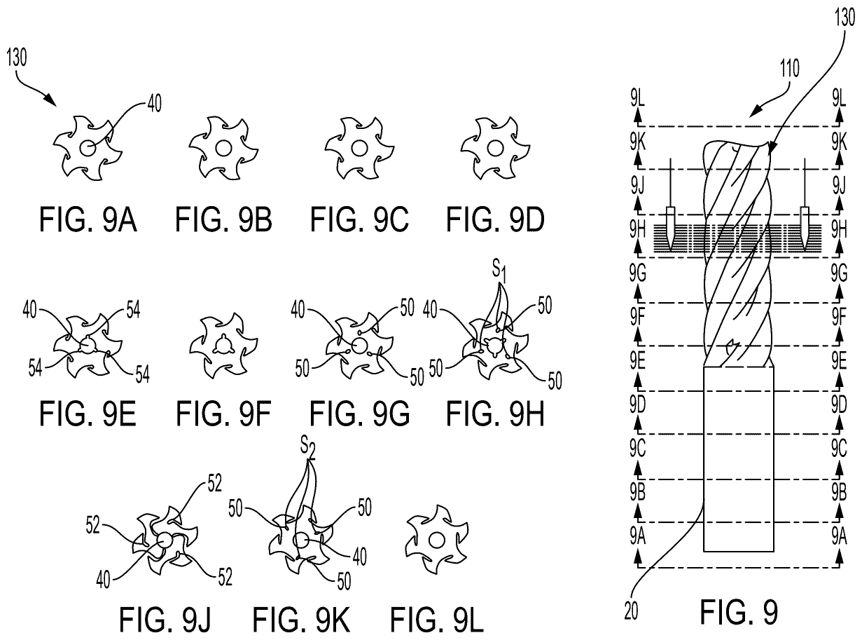

FIGS. 1-9 illustrate and describe features of rake-face through coolant channels and outlet ports in accordance with embodiments of the invention. As shown in FIGS. 1-8, cutting tool 10 includes a shank portion 20 and a cutting portion 30 defining a longitudinal axis L. The cutting portion 30 includes helical flutes 32 and peripheral cutting edges 34 defining rake faces 36 and flank faces 38. A central coolant supply channel 40 extends through the shank portion 20 into the cutting portion 30. Contoured radial coolant channels 50 extend from the central coolant supply channel 40 and terminate at radial coolant outlet ports 52 that are directed toward the rake faces 36. Each contoured radial channel 50 has an inlet 54 communicating with the central cool supply channel 40. As shown in FIGS. 9 and 9A-9L, a cutting tool 110 including a cutting portion 130 includes similar features as shown in FIGS. 1-8. A first set S₁ of the contoured radial coolant channels 50 is provided as shown in FIG. 9H, and a second set S₂ of the contoured radial coolant channels 50 located axially forward of the first set S₁ is provided as shown in FIG. 9K.

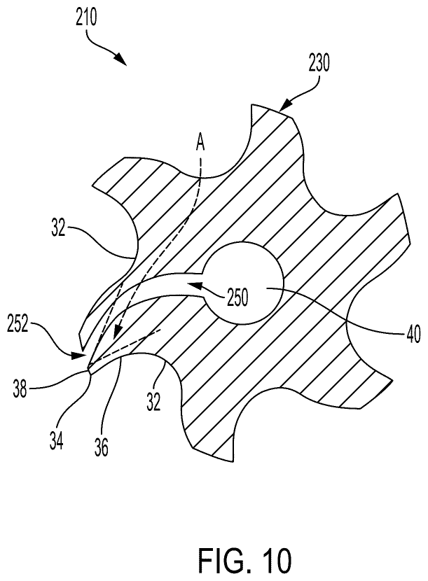

### Type 2: Flank-Face—FIG. 10

Another embodiment of the present invention is to direct coolant along a flank face of a cutting tool at relatively steep angles. Coolant holes can be positioned along flank faces at steep angles through the use of additive manufacturing.

FIG. 10 illustrates an embodiment of a cutting tool 210 and cutting portion 230 having a flank-face through coolant channel and exit port arrangement in accordance with an embodiment of the invention. The contoured radial coolant channels 250 have outlets 252 located at the flank faces 38 of the cutting portion 230. The coolant outlet angle A shown in FIG. 10 may be at least 10°, or at least 20°, or at least 30°.

In accordance with embodiments of the present invention, a rotary cutting tool, such as a solid end mill, may include a shank portion and a cutting portion extending forward from the shank portion along a central longitudinal axis. The shank portion may be cylindrical in shape. The cutting portion may include flutes and peripheral cutting edges. Although helical flutes are shown in the figures, it is to be understood that any other suitable flute shape may be used, such as straight flutes. The cutting portion may include one, two, three, four, five or more flutes.

The shank portion may include a central coolant supply channel extending through the interior of the shank portion along the longitudinal axis. The central coolant channel extends from a rear coolant channel inlet located at the shank rear surface through the shank portion and into the cutting portion. The central coolant channel may be cylindrical in shape or any other suitable shape. The central coolant channel may extend to a coolant manifold located in the cutting portion. The central coolant channel is structured and arranged to receive a coolant fluid during operation of the rotary cutting tool, and may receive coolant fluid from a fluid source (not shown).

Contoured radial coolant channels are in fluid communication with the internal central coolant channel. Each contoured radial coolant channel may begin at a radial coolant channel inlet port located adjacent the central coolant channel and/or at a coolant manifold, and may terminate at a radial coolant channel outlet port.

As used herein, the term “radial”, when referring to the coolant channels, means that a channel extends in a direction having a component in a radial direction extending perpendicularly outward from the central longitudinal axis. The term “contoured”, when referring to the radial coolant channels, means that at least a portion of the channel extends in a non-linear or non-straight direction along its flow path length and/or at least a portion of the channel has a non-uniform cross-section as the channel extends along its length from its inlet port to its outlet port.

Each contoured radial coolant channel and outlet port may define a coolant flow direction that may be controlled to provide improved cooling of the cutting edges of the tool. Each radial coolant channel outlet port may have a cross-sectional exit length and exit width. Each coolant channel inlet port may have a cross-sectional inlet length and inlet width. The cross-sectional shape of each contoured coolant channel may change over its length. The radial coolant channel outlet ports may be slot shaped, oval shaped, tear drop shaped, or may include another suitable cross-sectional shape.

The cross-sectional area of each outlet port may be less than the cross-sectional area of the inlet to each contoured radial coolant channel, e.g., at the intersection with the central coolant supply channel. A decrease in cross-sectional area of the contoured radial coolant channel may cause an increase in velocity of the coolant fluid as it flows through the contoured radial coolant channel.

The shape of each radial channel outlet port may be structured and arranged to cause the coolant fluid to expand or fan out as it exits the outlet port. The coolant fluid may fan out in a direction parallel or substantially parallel with the peripheral cutting edge. The contoured radial coolant channels may have curved shapes which facilitate coolant flow patterns during operation of the rotary cutting tools.

The cutting tools may be manufactured using any suitable manufacturing technique such as additive manufacturing. The entire rotary cutting tool may be manufactured with additive manufacturing, or only a portion of the cutting portion may be manufactured with additive manufacturing. Non-limiting examples of additive manufacturing techniques include binder jetting, directed energy deposition (DED), material extrusion, material jetting, powder bed fusion, sheet lamination, and/or vat photopolymerization. The use of additive manufacturing of the entire rotary cutting tool or the cutting portion may aid in forming the contoured radial coolant channels along the length of the central coolant channel.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention.

What is claimed is:

1. A cutting tool comprising:
a shank portion;
a cutting portion extending from the shank portion along a longitudinal axis comprising at least one peripheral cutting edge;
a central coolant supply channel extending within the shank portion; and
at least one contoured radial coolant channel in fluid communication with the central coolant supply channel extending radially outward from the central coolant channel to a radial coolant channel outlet port adjacent the at least one peripheral cutting edge.

2. The cutting tool of claim 1, wherein the coolant channel outlet port is directed toward a rake face of the cutting tool.

3. The cutting tool of claim 2, comprising a plurality of flutes adjacent the peripheral cutting edges forming rake faces, and each radial coolant outlet port is located in one of the flutes and directed toward a respective one of the rake faces.

4. The cutting tool of claim 3, wherein each of the contoured radial coolant channels is structured and arranged to deliver coolant fluid from its radial coolant channel outlet port toward one of the rake faces.

5. The cutting tool of claim 4, further comprising multiple sets of the contoured radial coolant channels located at different axial positions along the longitudinal axis of the cutting portion.

6. The cutting tool of claim 5, comprising:
a first set of the contoured radial coolant channels located along the longitudinal axis structured and arranged to deliver coolant fluid toward the rake faces; and
a second set of the contoured radial coolant channels located axially forward of the first set of the radial coolant channels along the longitudinal axis structured and arranged to deliver coolant fluid toward the rake faces.

7. The cutting tool of claim 6, further comprising a third set of the contoured radial coolant channels located axially forward of the second set of the radial coolant channels along the longitudinal axis.

8. The cutting tool of claim 3, wherein the at least one flute is helical.

9. The cutting tool of claim 1, wherein the coolant channel outlet port is directed toward a flank face of the cutting tool.

10. The cutting tool of claim 1, wherein the at least one contoured radial coolant channel extends forward along the longitudinal axis from an inlet adjacent the central coolant channel to the radial coolant channel outlet port.

11. The cutting tool of claim 1, wherein the at least one contoured radial coolant channel comprises a non-linear curved portion along a length of the contoured radial coolant channel.

12. The cutting tool of claim 11, wherein the non-linear portion extends along the entire length of the contoured radial coolant channel.

13. The cutting tool of claim 1, wherein the at least one contoured radial coolant channel comprises a non-uniform cross-section along a length of the contoured radial coolant channel.

14. The cutting tool of claim 1, wherein the at least one radial coolant channel outlet port comprises a cross-sectional exit length that is greater than a cross-sectional exit width.

15. The cutting tool of claim 1, wherein the at least one radial coolant channel outlet port has an elongated cross-sectional shape.

16. The cutting tool of claim 1, wherein the rotary cutting tool is a solid end mill.
